(19) United States
(12) Patent Application Publication
(10) Pub. No.: US 2008/0120289 A1
(43) Pub. Date: May 22, 2008

(54) Method and systems for real-time active refinement of search results

(76) Inventors: Alon Golan, Tel Aviv (IL); Uzi Ezra Havosha, Tel Aviv (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/602,700

(22) Filed: Nov. 22, 2006

(51) Int. Cl. G06F 7/06

(52) U.S. Cl. 707/5; 707/E17.108

(57) ABSTRACT

A computer utility for any kind of search engine or data that provides a graphical user interface for displaying search results and live refinement of the results, by automatic changing and/or offer to change the results list in real time, according to the user's demonstrated navigational interests.

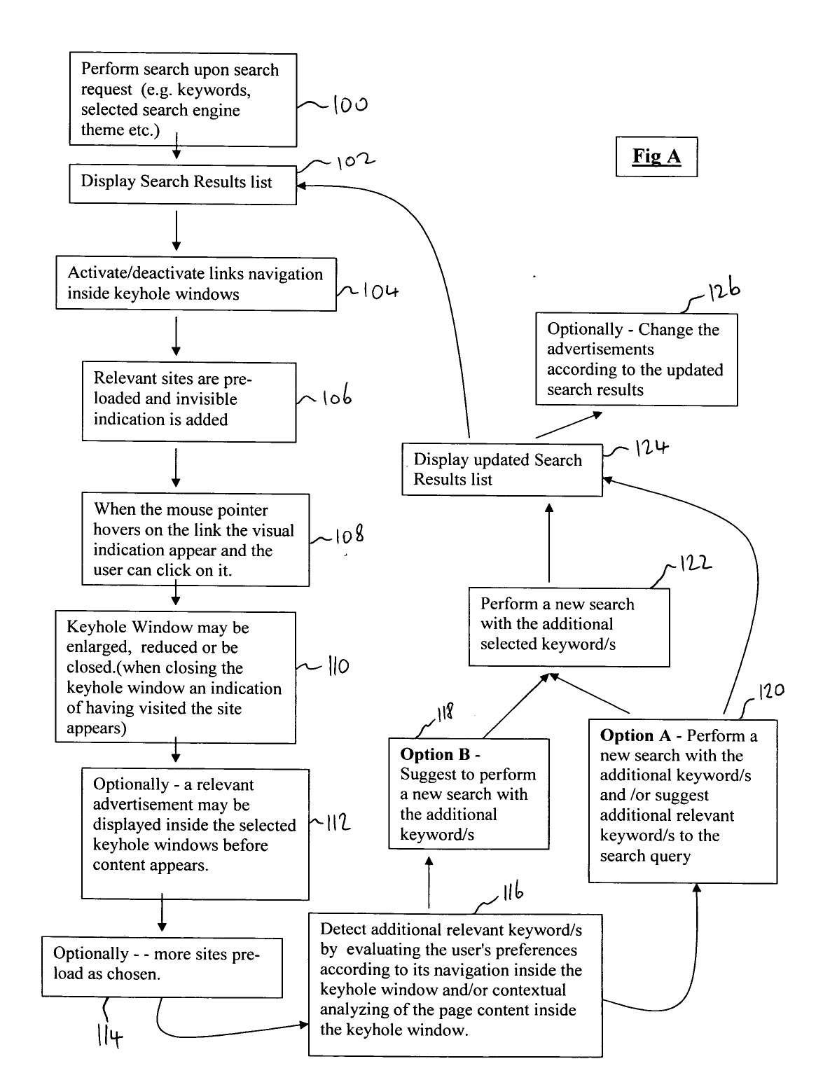

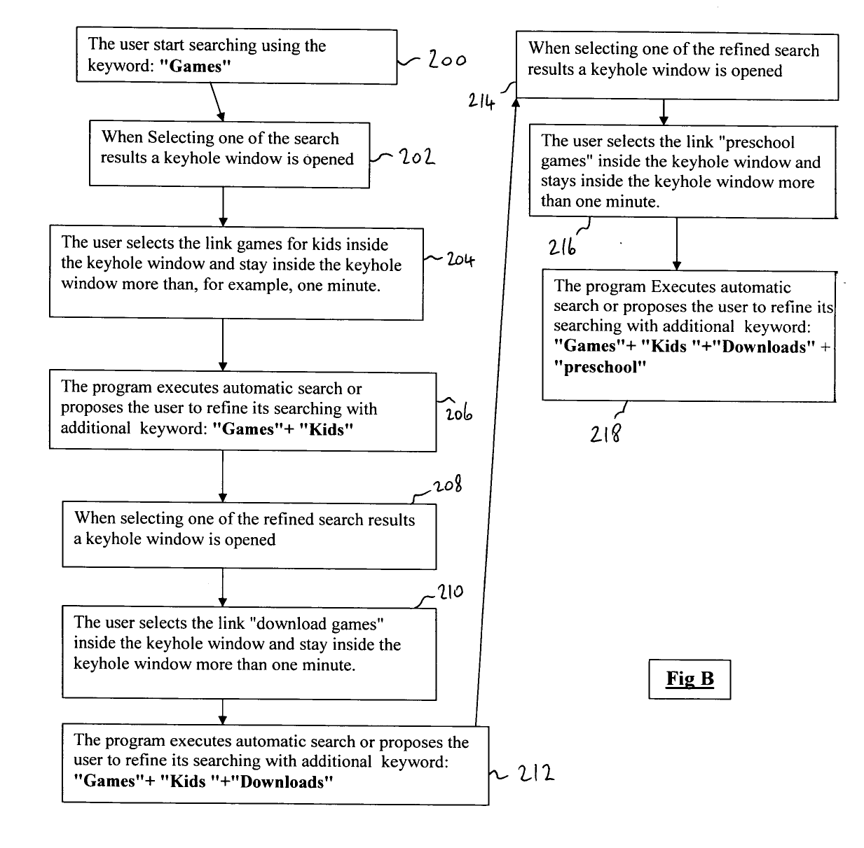

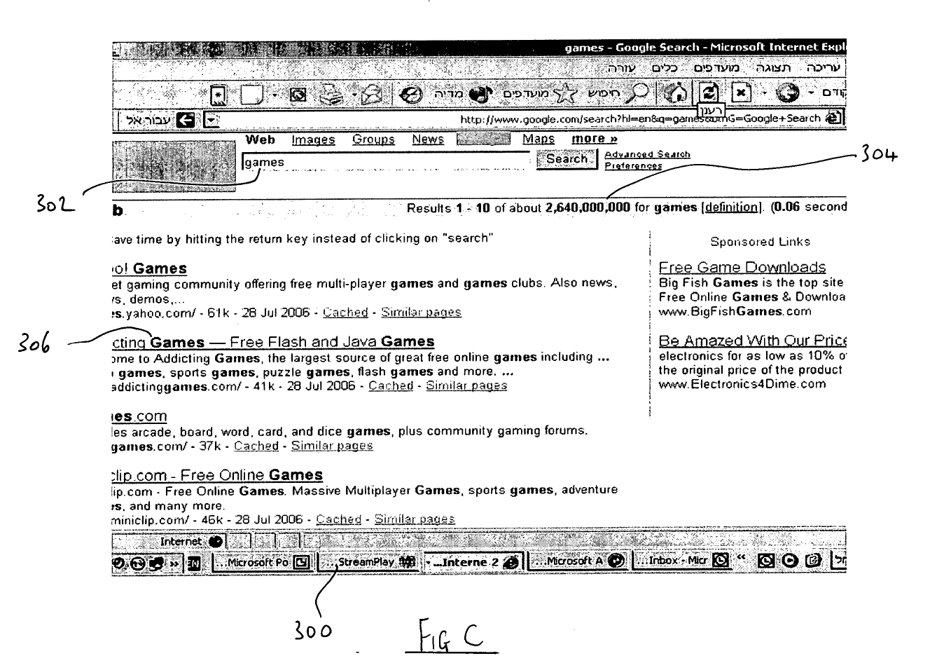

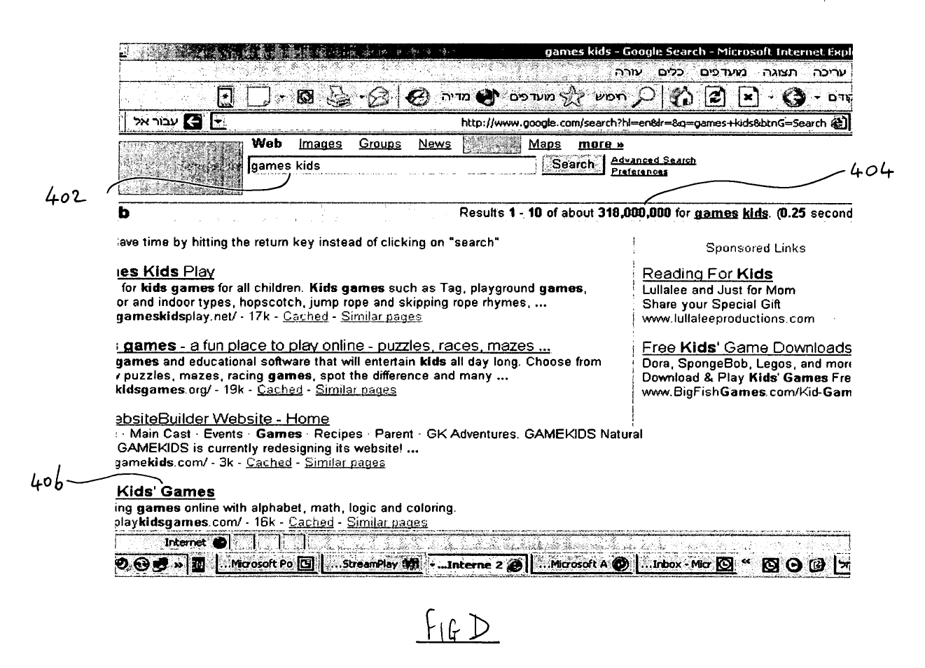

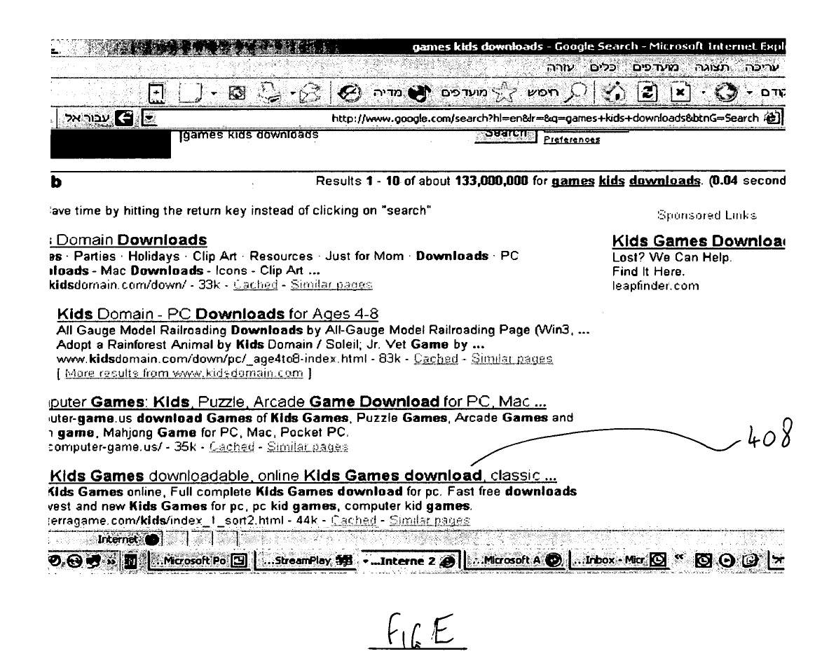

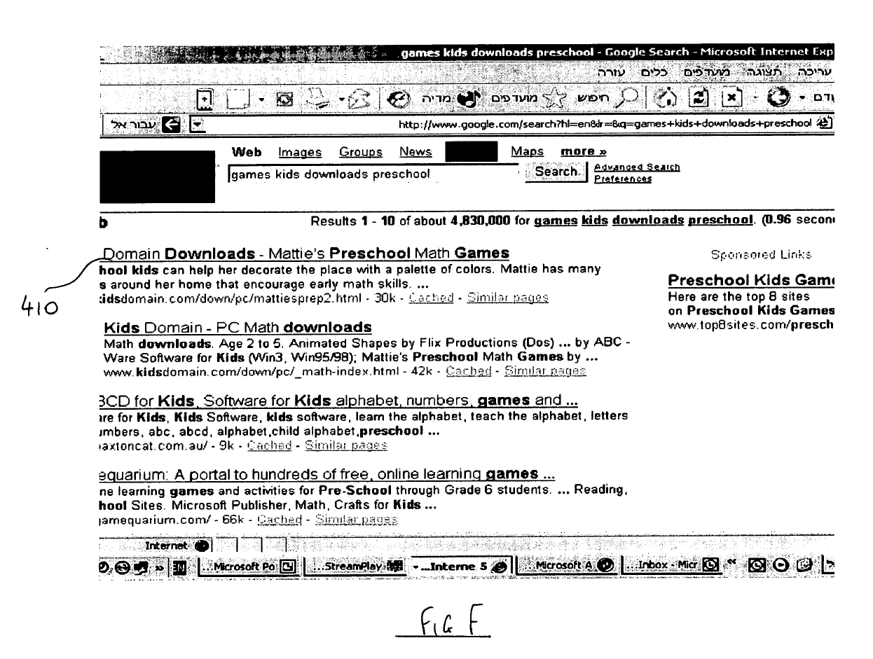

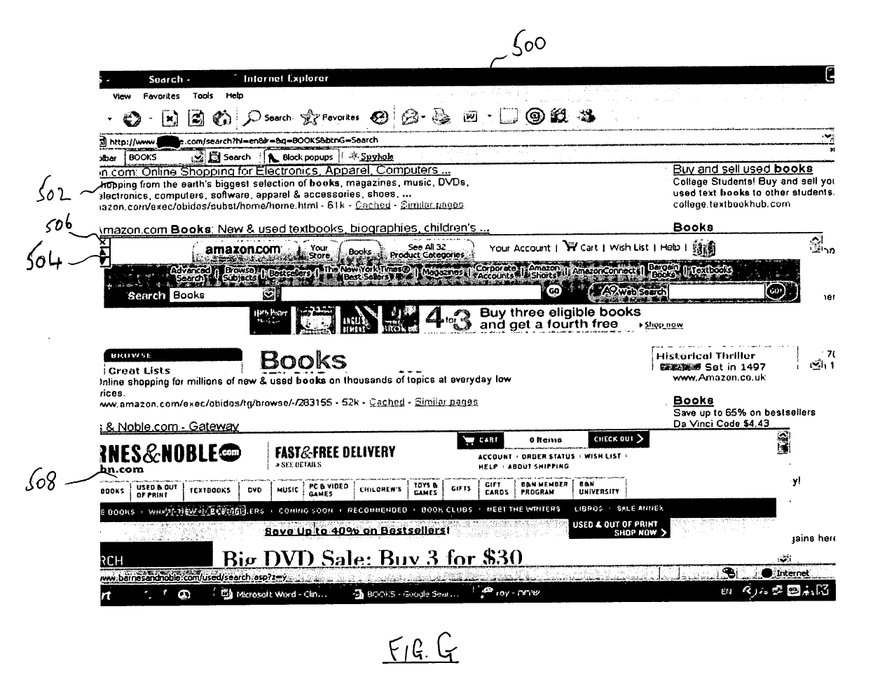

The graphical user interface includes resizable windows, configured to display the contents of the links (“keyhole windows”) The search results list may be dynamically altered by real time re-searching according to the reaction of and browsing movements of the user examining the search results. In the keyhole windows users may independently browse through and view content contained therein including links.

This invention detects user intention based upon its viewing and browsing of linked websites inside the keyhole windows. Thus, the user can more easily browse through the most relevant websites for him.

This invention may also support viewing and browsing through any kind of links content which may be found in other software programs for example, e-mails, games, advertising, web search results, data bases, Internet Protocol Television (IPTV) or index lists giving real-time re-searching of any kind of search results or index lists thereby making the user's search more efficient and time saving.

In the case of advertising, the user will be presented with selected advertising more suitable to his needs and desires and the advertiser will catch an audience with an initial sympathy towards the product being advertised.

### FIELD OF THE INVENTION

The present invention relates to search engines, data bases, indexes any kind of links, such as those in the Internet and Worldwide Web and also in the Internet Protocol Television (IPTV). The present invention comes to help internet browsers and any other users who use networks or software that include any kind of search engines, indexes and links. It is also applicable to advertising.

It relates to presenting and browsing contents of links such as network based search results in a keyhole windows and real-time re-searching of the search results list according to the user's intention, predicted mainly by his keyhole windows navigational preferences.

### BACKGROUND OF THE INVENTION

Searching, browsing and surfing internet web sites are commonplace activities today and do not need further explanation by way of introduction.

As more and more information is created and stored in electronic format, and as paper documents are converted into electronic format, finding relevant data among this increasingly large body of information becomes increasingly difficult. The volume of information accessible via the world wide web system, for example, continues to grow at an exponential rate. Furthermore, as memory technology has improved in capacity and performance, the amount of information that may be stored on a computer, or otherwise made accessible, also continues to increase.

To assist users in finding relevant data among these large bodies of information, programs known as search engines have been developed to generate search results in response to the user's search words. These programs endeavor to produce results that most closely match the search words.

Thus, for example, a standard method of searching for any item on the internet is by entering at least one search word into a search box of a search engine.

The result of this search usually produces many possible answers. The number of answers depends partly on the degree of accuracy of the search words used in the search. The more general the search words the larger the number of answers.

A search can produce millions of answers in less than a second. Clearly, a person can check only few of those answers. The computer program is made to arrange the answers in the order it is programmed to be most likely to be useful to the searcher according to the search words used.

Nevertheless, this order is not always what the searcher wants and he is left to search dozens of web sites to find the one that answers his needs. This can be a very time consuming exercise and often causes the person to miss search results of interest to him because of the excess volume of search results listed not necessarily in the best order for the searcher.

Search engines use different ways to try to find information most relevant to user's search words. For example, index-based search engines index internet documents to facilitate searching. The search engine takes the bare and literal words used by the searcher and usually fails to take into account words having a similar meaning to words of a search query. The difficulty is that the computer can only react to and search according to the input information.

Even when only a few internet sites are required to be looked at, it still takes an unnecessarily long time. The results of such a search are shown on the computer screen as URL (universal resource locator) addresses with a short description of relevant information contained in that web site. Often ten such addresses are shown on each page of the search results. A searcher can choose which URL to open and can move to which page he wishes, in any order he desires. His main difficulty is to find out as quickly as possible which of the many search results is relevant to him.

Significant efforts have been directed toward improving the search algorithms and methods utilized by search engines and similar programs, predominantly driven by the increase in the volume of information and the resulting increase in difficulty in filtering out from the mass of data produced from a search, the results most likely to satisfy the user.

In many cases, however, a basic obstacle to the ability of a search engine to generate an optimal result is the initial quality of the search words used by the searcher. Many search engines use a relatively complex language that enables skilled users to more accurately describe for what lo they are searching. However, the amount of skill required to generate searches in this manner often exceeds that of most users, and as a consequence, many searchers are unable to take advantage of such advanced search language and techniques in order to properly describe their queries and to produce the desired results.

It is this problem that this invention seeks to solve. That is to say, to create an “intelligent” computer program and method that can identify the searcher's real desires even though he does not express them in his search words. There are existing art search engines that attempt to make searches suit the needs of the searcher. Such attempts at personalization operate using parameters about the searcher from direct or indirect sources. They collect data about the searcher like his age, occupation, address, interests and the like, in order to build a personal profile. This profile is then used to adjust the order of the search results.

The obvious difficulty with this approach is that computers are often used by different people and it does not always request to identify the user.

Other methods used by search engines attempting to overcome the above mentioned difficulties are to take search words used by the searcher earlier in that searching session and use those search words to order the results of a current search. This also has the difficulty that the first searches will not benefit from this extra information, a previous searcher on that computer would introduce irrelevant information for a future searcher and it could be that search words used in previous searches are incorrect or unwanted for a current search. The computer would not “know” this information and thereby produce less desirable search results.

There is currently little work on personalizing web search results based on the user's real-time navigation.

Moreover, significant efforts have also been directed toward the optimization of web page keywords in order to get high ranking in the search results but there are still difficulties with those attempts at solving this problem from the point of view of the searchers and the search engines.

What is needed is a system that can understand what searchers are really looking for in real-time searching, compare the data in a database like for example, the internet, and produce real-time change in search results for finding the closest information to that which the searcher desires.

This invention provides the user with real-time re-searched results based upon the searcher's actual web viewing and navigation inside the keyhole windows.

In addition, when a person searching thinks a site looks as if it may have relevant information in it, he will “click” the screen cursor on the URL/link and that web site will begin to open. This site opening procedure is a time consuming process. When the searcher has finished looking at that site and wants to inspect another site he needs to click on the “back” button to see the original list of search results and choose another URL. If he visited a number of linked sites, he has to close all of them to find the search results page. If he wishes to go back to a site he previously saw something of interest to him, he has to remember which site it was and open it again. It is a “horizontal” direction of operation. This tedious procedure continues until the person finds the site and information he is looking for or he terminates his search efforts, frustrated. Moreover, losing primary view of the current web page is often undesirable for the user, particularly when the user is merely attempting to view and browse the resources associated with the hyperlinks on the current web page for example, in-page browsing of the web search results. To regain primary view of the current web page, the user must instruct the browser to return to the current web page or return focus to the browser window displaying the current web page. However, such operations are relatively slow.

Furthermore, managing a number of active browser windows or continuously navigating back and forth among multiple web pages while looking for desired content can be too complicated for many users.

Another aspect of this invention involves advertising. The major search engines operate a Pay Per Click (PPC) advertising system to produce revenue. This system works by the highest bidders being listed first in text search results list in descending order and the advertiser is charged when a searcher clicks on an advertiser's URL. The search engine companies earn more when searchers open many advertisers' web pages.

Textual search results do not give enough nor sufficiently accurate information about their content and thus the user has to click many search results, whether or not they are relevant to him. It causes a waste of time for the searcher and a waste of money for the advertiser as he has to pay even though the user is not interested in the advertiser's website content. Search engine companies do not have an interest to change the system as they gain financially from this inefficiency.

This invention comes to assist searchers and advertisers in this respect.

Existing art relies on having the co-operation of the search engine companies to enable their programs to work with the search engine programs. This innovation works externally and independently from the search engine programs. Some progress has been made in the field of pre-viewing search results for example, US Patent Application No. 20020129051 issued to Abdelhadi et al.; US Patent Application No. 20040205633 issued to Martinez et al.; US Patent Application No. 20040205514 issued to Sommerer et al.; US Patent Application No. 20050251736 issued to Ran et al. and US Patent Application No. 20050278321 issued to Vailaya et al.

The above prior art uses a method to provide the searcher with a preview window but their disadvantage is that they are operated by the search page operating company and whose source of operation is only that particular search engine and is limited to their server. In other words those companies have a server solution and do not provide client side solution. Thus, a browser using a different search engine that does not use a preview program, would not be able to enjoy the benefits of the keyhole windows program.

The prior art also has the disadvantage of using a lot of “ram” memory of the user's computer as the preview pages load up. This is because all the sites on the first page of results load up when the page is displayed. When a second page of the search results is chosen to be searched all those URLs will be loaded up, using another large amount of memory.

Furthermore, the prior art, in most cases, does not enable the end-user to choose the size of window of those previewed sites. Even in those cases where there is some choice, it is limited to few fixed window sizes and/or depend on previous configuration by the user.

What is called for is a method to make this searching a more user-friendly procedure. What is needed is a “vertical” direction of operation. The searcher needs quick access to numerous web sites which were offered as possible results of the search. He needs to see on the search results page, a portion of the opening page of that web site (not just two lines extracted from the site). The keyhole window ideally needs to be adjustable in size to be larger and smaller as suits the user's purpose. He needs the ability to browse in those pre-view web sites as deeply as he desires, visiting hyperlinks as desired and be able to swiftly return to the original pages of those search results in order to browse other web sites. He also needs to keep examined sites within easy access so that they can be re-examined, if necessary. Finally, there is called for a method of giving this improved service to web site users on sites other than those owned or controlled by the search engine companies.

There is also a need for dynamic and real-time changing and re-searching of any kind of search results based upon the user's real-time navigation preferences learned from its actual navigation through the keyhole windows.

This invention with the client-side keyhole windows program gives its owners an ability to optimize the search results and to change the list dynamically in real time, according to the user's real interests which have been learned from his actual navigation inside the keyhole windows.

In addition, it gives the programs owner opportunity to provide more relevant advertising to the user according to the subject of the links he chooses to view inside the keyhole windows.

In the context of real-time re-searching with attempts at intelligent assessment of the real-time needs and desires of the searcher, there are also a number of prior patents and patent applications but none of them achieves the degree of accuracy and sophistication of the present invention.

Patent application No. 20040122816 made by Kirkland et al., Patent application No. 20060074883 made by Teevan et al., Patent application No. 20050240580 made by Zamir et al., Patent application No. 20060136405 made by Ducatel et al. and Patent application No. 20060161520 made by Brewer et al.

The above applications attempt in their individual ways to solve the problem of providing more personalized search results for the searcher or consumer in the context of advertising.

U.S. Pat. No. 7,047,502 issued to Petropoulos et al. reveals a method of previewing contextually relevant information. It also enables to forward the attributes of the user behavior across the network to a program-designated place and later used in a consideration process, which will lead to conclusions about the relevance of the results originally presented. However, it does not perform dynamic and real-time changing of the search results and/or re-searching based upon the user's real-time navigation preferences learned from its actual navigation through the keyhole windows.

It also display only a preview windows and does not enable the user to browse through keyhole browser windows, nor does it adjust its results based on the browsing negotiation 10 behavior of the user.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

The invention addresses the above mentioned and other problems associated with the prior art by attempting to optimize search results generated in response to a search query. This is achieved by analyzing the actual navigation of the user inside the keyhole windows length to identify one or more additional keywords that, when applied to the search results, would serve to optimize the result set and improve upon the initial query.

The present invention provides a method, and computer program product for real time interactive, intelligent searching of data elements, including data management 10 technology that can understand what users are looking for, understand the data in a database, and present immediately updated search results.

Suggestions and operations are presented to the user that enables him to further focus a search intelligently in real-time.

In the present invention, web pages links and search results arising from the searching query, may be viewed and navigated through keyhole windows, being selected by the user. The user may then examine results within keyhole windows without leaving the main page.

In another aspect of the present invention, the user's examination of the search results is used to automatically change the search results as the user completes viewing of a particular result inside the keyhole windows and returns to a group of results for selection of the next item for review.

Alternatively, the user can choose to have new search words offered to him and he can choose to use them to refine his search (“manual search refining”). There is also the possibility to combine the aforementioned features of automating search refining with manual search refining. As a consequence, criteria gleaned from a user's examination of a particular result can be used to modify and change in real time, the overall search results to provide more relevant results to be presented to the user for review.

With these arrangements, the user applies a controlled filtering to the various search results so that those search results that best fit the user's needs and desires are presented in a highly ranked location to the user for further review.

As a consequence, having entered additional keywords, this invention causes the automatic and real-time re-running of the search with the revised criteria which will present the most relevant search results to the user.

Another possible embodiment of the invention may include option of dynamically re-ranking of the search results by automatic re-ordering or suggesting the user to re-order the search results and displaying the web pages matching the additional keyword/s before those that are not matching the additional keyword/s.

Another possible embodiment of the invention identifies and suggests to a user additional keywords that serve to effectively change the search results in order to match them with the user's demonstrated intentions automatically and concurrently with the user's browsing.

Consistent with one aspect of the invention, for example, a search is performed in response to a query that includes one or more keywords, after the user chooses one result and opens another link inside his keyhole window and/or staying inside the keyhole window for a long time. In response to the above user navigation, at least one additional keyword is identified, which is relevant to the above new link, and the search results are automatically changed in real-time based upon the additional keyword or keywords according to the user preferences learned from its navigation inside the keyhole windows.

Another object of this invention is to give the browser a convenient tool for identifying the sites he has visited and for identifying those sites he has yet to visit.

Another object of this invention is to enable the browser to browse and see his desired site as a smaller screen superimposed on the original search result page.

Another object of this invention is to enable the browser to choose the size of the said smaller screen and enlarge it in stages until it reaches a full sized screen and reduce it in stages.

Another object of this invention is to do an action called “pre-fetch” which loads up a pre-determined number of web sites into the ram memory, thereby speeding up the browser's access to those pre-fetched sites.

Another object of this invention is to visit a web site within a URL address while keeping the main search page visible on the screen and accessible.

Another object of this invention is to enable the browser to alternate with ease between sites visited.

Another object of this invention is to enable the program to work from the domain of the browser's computer and operate on any web sites used by the browser.

Another object of this invention is to enable the program to work also as client side program installed in the browser's computer (such as part of toolbar/deskbar applications).

Another object of this invention is to enable the program owners to provide the user relevant advertisement targeted advertising) by learning its interests according to its navigations through the previewed links.

Another object of this invention is to apply the invention to web search engines, gambling web sites, internet shopping sites, IPTV and any other application where many web sites are desired to be visited whether briefly or in depth, whether such depth means visiting other sites at the same URL address or linked sites with different URL addresses.

Another object of this invention is to apply the invention to other software applications where many links are desired to be visited whether briefly or in depth, whether such depth means visiting internet web sites or linked software applications. Program Games such as gambling software may be a good example to that kind of software that includes links to many kind of games. Thus this invention can provide the gamers an option to play in more than one game at the same time in the same window (e.g two or more poker games, black jack, view two or more horse races, football games etc.).

It is emphasized that this invention is not limited to web HTML pages only and it may be applied to many kind of software applications, such as java, applets, flash and the like, as long as they include links to other pages, sites, files, documents, software applications and the like.

In addition to the above, which shows how to adjust search results according to the user's navigation, the same program and system can be applied to advertising. The user's navigation is recorded and re-searching carried out in order to better choose advertisements suitable for the needs of the user. Likewise, advertisers will be exposed to more receptive potential customers. The preferred embodiment detects interests of the user, based on the pattern of his navigation in search results selected, without having to receive explicit instructions from the user. It is sensitive to change and adjusts as the user changes his interest. It is applicable in search results, researching dynamically to review and renew advertising material.

The preferred embodiment enables publishers and advertisers to create custom audiences for their advertisements based on users' demonstrated real behaviors across their sites. Because advertisements will target relevant users, and not pages, publishers can sell more of their site's inventory at a higher clicks per minute and advertisers can improve coverage and improve cost-per-acquisition.

The preferred embodiment real-time behavioral targeting solution allows advertisers to direct their advertisements at consumers based on their behavior while navigating across a site. The advertisements exposed to user's will be more relevant to their demonstrated needs and desires.

Advertisers can dynamically adjust coverage and relevance, resulting in a better tailored audience to meet their advertising objectives.

This invention means an increased ability to optimize marketing expenses. Publishers and advertisers can reach qualified audiences based on their real-time behaviors and thereby market more strategically. With the control that the preferred embodiment provides, publishers and advertisers can provide advertisements more suitable to consumers. The preferred embodiment can automatically personalize advertisements using behavior and can work with behavior tracking. The preferred embodiment dynamically selects the right type of advertisement for the right user at the right point in time. As users' navigate for example, the internet, their interests and behavior changes are used to dynamically change the kinds of advertising. This invention is a powerful advertising tool and also is likely to lead to greater revenues for the advertisers and more satisfaction for users.

Using the preferred embodiment leads to lower cost-per-acquisition (CPA) for advertisers, and better click-through rates (CTR) for search engines and publishers. In addition to simply changing a key message in an advertisement, the preferred embodiment can also respond by automatic personalizing and customizing advertisements exposed to each user individually. An additional benefit is that this invention can work in situation where there is no relationship yet between the advert and the user. An advertiser may want to get a new product in front of a target audience that may not have indicated their interest in such products. The reactions of the user will enable the advertiser to suggest more of the same kind or advertise in a different area. Advertisers could test markets and react in real-time.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. A is a flowchart showing some of the actions and options of this invention in sequence.

FIG. B is a flowchart showing an example of the workings of the dynamic real-time re-searching according to this invention.

FIG. C is an example of the results of a web search.

FIG. D is an example of an automatically refined and re-searched web search based on the user's browsing in the web search of FIG. C.

FIG. E is an example of an automatically refined and re-searched web search based on the user's browsing in the web search of FIG. D.

FIG. F is an example of an automatically refined and re-searched web search based on the user's browsing in the web search of FIG. E.

FIG. G is a sample search result showing the keyhole window

### DETAILED DESCRIPTION AND PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

The present specification also discloses methods for performing the operations herein described. Such methods may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate.

FIG. A shows in flowchart format some of the steps involved in the operation of this invention. Initially, the user decides on the most appropriate search words for his search request and enters that word or words to perform the search 100. Within a short time the results of the search are displayed 102. There appears an activate/deactivate display 104 leading to the links that enable navigation inside keyhole windows. At the same time a predetermined quantity of sites are preloaded 106 and an invisible indication is noted next to those preloaded sites. When the computer mouse pointer is brought to hover over one of those links, the said indication is displayed 108 and the user can choose to click on the link, whereupon the keyhole window opens. The keyhole window can be enlarged, reduced or closed as desired by the user 110. If the user closes the keyhole window, an indication remains to remind the user that he has visited that site.

At this stage there could be advertising displayed 112 that is relevant to the subject matter of visited sites. This advertising could be within the bounds of the keyhole window.

The user could browse inside the keyhole window displayed or could open other links 114. This browsing negotiation is used by the computer program of this invention to select additional relevant search words for the user to use to search a re-fined search 116. The user could be offered these additional search words 118 so that he can decide which words are most suitable for his needs. Alternately, the new search could be performed automatically 120. Either way when a new and refined search is performed, 122 a new updated search result would be displayed 124 and the cycle of steps from FIG. A 102 would be repeated. The option of this invention being applied to dynamic advertising 126 could display adjusted advertising based on the new and refined search results. Each time the cycle of refined searching is done the advertising would be refined accordingly, maintaining the relevance to the refined search and results.

FIG. B is a flowchart showing by way of example the steps involved in automatic re-searching based on the user's browsing negotiations. The user wishes to download games for young children. He enters the word “games” into the search box 200. The user sees the search results and selects one of them 202 whereupon a keyhole window is opened for that address. The link selected by the user and the length of time spent by him at a certain site gives the indication to the computer program of this invention that the user really wants to limit his search to games for young children. The program therefore either offers the new search words or performs a new search automatically using the words “games and kids” 206.

The user then clicks on the next URL address 208 that he anticipates to be closer to that which he is looking for. In the example above mentioned the user clicks on a link that enables downloading the kids games 210. This invention once again detects this interest in downloading and either offers new possible search words or actually performs the refined search including “games and kids and download” 212. The user selects another URL 214 of interest to his search involving pre-school age kids and browses inside one keyhole window for more than a specified time, say one minute 216. The program will either offer new search words or perform the refined search again automatically adding the word “preschool” to the previous search words 218. In this way the user is always presented with updated search results closest to his target subject-matter.

FIG. C shows a sample of search results page 300 where the user wrote the initial search word “games” 302. The search produced more than two billion results 304, of which the first few appear 306 on the first page of the search results. FIG. D shows the narrowed search results after the word “kids” has been added 402 and the refined search performed automatically. This search produced many less results 404 all more specific than the previous search as they all contain the words “games” and “kids” 406.

FIG. E shows the same pattern of even more specific results with the added word “downloads” 408.

FIG. F shows the final search resulting from the user's browsing navigation where the search results all contain the words “games, kids, downloads and preschool” 410. The user just browsed in sites that looked of interest to him and automatically he would be presented with a new and more specific list of search results 410.

FIG. G shows an example of the keyhole opening of addresses 500 that have been clicked on. The site can be open larger or smaller and the user can browse therein while the main search page results remains on the screen 502, available for him to return to with ease, in order to search other sites. The keyhole window 502 can be enlarged or lessened by clicking on the arrows 504, or closed by clicking on the “x” 506. A closed site will be recognizable by a sign to show it is a visited site. More than one keyhole window can be opened on one page 508 and browsing in these windows will produce the automatic refining of the search results on the first page as described above.

In various implementations of the invention Mouse pointer may be a common pointer as may be controlled by any kind of mouse, keyboard pointer, touch screen, remote control or any user manageable device.

Moreover the keyhole windows may be located anywhere on results page and may also be displayed as floating window.

For concluding on additional relevant keywords the program may analyze any combination of the following data and any other relevant data:

a) The duration of navigation time inside the keyhole windows;

b) The contextual information of the page inside the keyhole windows;

c) The contextual information of link which has been selected by the user inside the keyhole windows

d) The contextual information of link which the user selects to fully open in the main page after opening the keyhole window of that link.

These analyzing may be combined with other searching techniques for relevant keywords suggestion such as Personalized search methods.

Accordingly, a system and method has been described that permits real-time automatic identification of personalized additional search-words that may be used to improve the relevance of a search query in order to better serve the interests of searchers and of advertisers. The foregoing describes only some embodiments of the present invention, and modifications and/or changes can be made thereto without departing from the scope and spirit of the invention, the embodiments being illustrative and not restrictive. Therefore, the invention lies in the claims hereinafter appended.

What is claimed is:

1. A method for viewing links inside a keyhole windows and operating real-time re-search with relevant keyword/s comprising the process steps of:
retrieving links such as search results,
displaying the chosen linked pages in keyhole windows,
enabling browsing inside the keyhole windows,
enabling re-sizing of the keyhole windows,
observing and evaluating the behavior of a user as he examines links and web pages inside keyhole windows,
identifying relevant keywords according to the said behavior,
performing a real-time search or re-search with the relevant keyword/s,
thereby enabling the user to focus on links and search results that are closer to his desired target.

2. A method as claimed in claim 1 wherein the said identification of relevant keyword/s is based on content of the links the user opens in the main page and/or inside the keyhole windows, such as, their subject, keywords, references, relevant contextual information etc.

3. A method as claimed in claim 1 wherein the said identification of relevant keyword/s is based on the length of time the user stays in a particular keyhole window/s.

4. A method as claimed in claim 1 wherein the said identification of relevant keyword/s is based on content of the links he opens in the search results page after opening the keyhole window of that link, such as, its subject, keywords, references etc.;

5. A method as claimed in claim 1 wherein the said identification of relevant keyword/s is based on any combination of the following parameters:
a) the length of time the user stays in a particular keyhole window/s;
b) the content of the links the user opens in the search results page and/or inside the keyhole windows such as, their subject, keywords, references etc.;
c) the content of the link the user selects to open in the search results page after opening the keyhole window of that link, such as, its subject, keywords, references etc.; and/or
d) other searching methods for identifications of relevant keywords, such as personalized search methods whether or not based on the personal details of the user or previous searches or other user's similar searches.

6. A method as claimed in claim 1 wherein relevant search words are suggested to the user for him to use them at will to perform a search or re-search.

7. The method of claim 1, further comprising the step of: real-time re-ranking of search results by automatic re-ordering of the search results and displaying the web pages matching the said identified keyword/s before or without those that are not matching the said keyword/s.

8. The method of claim 7, wherein the said re-ranking of the search results is suggested to a user for him to execute it at will to perform re-order of the search results.

9. A method as claimed in claim 1 wherein the said searching is in the medium of network such as the internet world wide web

10. A method as claimed in claim 1 wherein the said searching is in the medium of data bases.

11. A method as claimed in claim 1 wherein the said searching is in the medium of television including the internet protocol television (IPTV).

12. A method as claimed in claim 1 wherein the observation and evaluation of the user's behavior as he examines links and web pages inside keyhole windows is for the purpose of displaying relevant and targeted advertising comprising the steps of:
taking into account the subject matter of visited sites and selected links inside the keyhole windows,
taking into account the length of time of the said visits,
taking into account the subject matter of the link the user selects to fully open after opening the keyhole window of that link; and/or
collecting other relevant information regarding the user and his interests thereby selecting advertisements to match more closely the said interests of the said user.

13. A computer program for executing a computer process for viewing links in keyhole windows and operating real-time re-search with relevant keyword/s comprising the process steps of:
retrieving links such as search results,
displaying the chosen linked pages in keyhole windows,
enabling browsing inside the keyhole windows,
enabling re-sizing of the keyhole windows,
observing and evaluating the behavior of a user as he examines links and web pages inside keyhole windows,
identifying relevant keywords according to the said behavior,
performing a real-time search or re-search with the relevant keyword/s thereby enabling the user to focus on links and search results that are closer to his desired target.

14. A computer program as claimed in claim 13 wherein the said identification of relevant keyword/s is based on any combination of the following parameters:
a) the length of time the user stays in a particular keyhole window/s;
b) the content of the links the user opens in the search results page and/or inside the keyhole windows such as, their subject, keywords, references etc.;
c) the content of the link the user selects to open in the search results page after opening the keyhole window of that link, such as, its subject, keywords, references etc.; and/or
d) other searching methods for identifications of relevant keywords,
such as personalized search methods whether or not based on the personal details of the user or previous searches or other user's similar searches.

15. A computer program as claimed in claim 13 wherein relevant search words are suggested to the user for him to use them at will to perform a search or re-search.

16. A computer program as claimed in claim 13, further comprising the step of: real-time re-ranking of search results by automatic re-ordering of the search results and displaying the web pages matching the said identified keyword/s before or without those that are not matching the said keyword/s.

17. A computer program as claimed in claim 16, wherein the said re-ranking of the search results is suggested to a user for him to execute it at will to perform re-order of the search results.

18. A method as claimed in claim 13 wherein the said searching is in the medium of network such as the internet world wide web or database or television such as IPTV.

19. A computer program for executing a computer process for observing behavior of a user as he examines links and web pages inside keyhole windows for the purpose of displaying relevant advertising comprising the computer process steps of:
taking into account the subject matter of visited sites and selected links,
taking into account the length of time of the said visits,
taking into account the subject matter of the link the user selects to fully open after opening the keyhole window of that link; and/or
collecting other relevant information regarding the user and his interests thereby selecting advertisements to match more closely the said interests of the said user.

20. The invention of claim 1 wherein the size, shape and location of said keyhole windows are configurable by the user.
